(19) United States
(12) Patent Application Publication
(10) Pub. No.: US 2015/0269269 A1
(43) Pub. Date: Sep. 24, 2015

(54) METHOD AND APPARATUS FOR GENERATING A DESKTOP SHORTCUT

(71) Applicant: TENCENT TECHNOLOGY (SHENZHEN) COMPANY LIMITED, Shenzhen (CN)

(72) Inventor: Bo Yang, Shenzhen (CN)

(21) Appl. No.: 14/730,305

(22) Filed: Jun. 4, 2015

Related U.S. Application Data
(63) Continuation of application No. PCT/CN2013/088117, filed on Nov. 29, 2013.

(30) Foreign Application Priority Data
Dec. 17, 2012 (CN) 201210551210.0

(51) Int. Cl. G06F 17/30; G06F 3/0484

(52) U.S. Cl. CPC G06F 17/30882; G06F 3/04842

(57) ABSTRACT

According to an example, a mobile terminal transmits a visit request for visiting Content Provider (CP) contents to a server, receives visit response information returned by the server, wherein the visit response information is generated by the server according to the visit request and includes a CP icon and a CP content link, and transmits a shortcut generating request containing the visit response information to a system of the mobile terminal through calling a system interface, such that the system of the mobile terminal generates a desktop shortcut for the CP contents according to the visit response information.

### CROSS-REFERENCE TO RELATED APPLICATIONS

This application is a continuation of International Application No. PCT/CN2013/088117, filed on Nov. 29, 2013. This application claims the benefit and priority of Chinese Patent Application No. 201210551210.0, filed Dec. 17, 2012. The entire disclosures of each of the above applications are incorporated herein by reference.

### FIELD

The present disclosure relates to Internet techniques, and more particularly, to a method and an apparatus for generating a desktop shortcut.

### BACKGROUND

In conventional reading fields, contents such as news, fictions, magazines provided by Content Providers (CPs) are distributed by papers. Users have to buy relevant books, magazines, or newspapers to read the CP contents.

With the developments of the Internet, users can browse CP contents via Personal Computers (PCs). At present, the content provider provides the CP contents to a browser server and the browser server distributes the CP contents configured by the content provider on the Internet.

When browsing the CP contents in the browser server, a user has to know the address of the CP contents so as to visit the CP contents. Specifically, the user has to input the address of the CP contents and open a webpage corresponding to the CP contents. Thereafter, the user can review the CP contents in the webpage.

### SUMMARY

According to an example of the present disclosure, a method for generating a desktop shortcut is provided. The method includes:

transmitting, by a mobile terminal, a visit request for visiting Content Provider (CP) contents to a server;

receiving, by the mobile terminal, visit response information returned by the server, wherein the visit response information is generated by the server according to the visit request and includes a CP icon and a CP content link; and

transmitting, by the mobile terminal, a shortcut generating request containing the visit response information to a system of the mobile terminal through calling a system interface, such that the system of the mobile terminal generates a desktop shortcut for the CP contents according to the visit response information.

According to another example of the present disclosure, a method for generating a desktop shortcut is provided. The method includes:

receiving, by a server, a visit request transmitted by a mobile terminal for visiting Content Provider (CP) contents;

generating, by the server, visit response information according to the visit request, wherein the visit response information includes a CP icon and a CP content link; and

transmitting, by the server, the visit response information to the mobile terminal, such that the mobile terminal generates a desktop shortcut for the CP contents according to the visit response information.

According to another example of the present disclosure, a mobile terminal for generating a desktop shortcut is provided. The mobile terminal includes:

one or more processors;

a memory; and

one or more program modules stored in the memory and to be executed by the one or more processors, the one or more program modules include:

a request transmitting module, adapted to transmit a visit request for visiting CP contents to a server;

a receiving module, adapted to receive visit response information from the server, wherein the visit response information is generated by the server and includes a CP icon and a CP content link; and

a shortcut generating module, adapted to call a system interface according to the visit response information, transmit a shortcut generating request comprising the visit response information to a system of the mobile terminal, such that the system generates a desktop shortcut for the CP contents according to the visit response information.

Other aspects or embodiments of the present disclosure can be understood by those skilled in the art in light of the description, the claims, and the drawings of the present disclosure.

### BRIEF DESCRIPTION OF THE DRAWINGS

Features of the present disclosure are illustrated by way of example and not limited in the following figures, in which like numerals indicate like elements, in which:

FIG. 1 is a schematic diagram illustrating an example embodiment of a computer system.

FIG. 2 is a flowchart illustrating a method for generating a desktop shortcut according to an example of the present disclosure.

FIG. 3 is a flowchart illustrating a method for generating a desktop shortcut according to another example of the present disclosure.

FIG. 4 is a schematic diagram illustrating a mobile terminal for generating a desktop shortcut according to an example of the present disclosure.

FIG. 5 is a schematic diagram illustrating a structure of a server for generating a desktop shortcut according to an example of the present disclosure.

### DETAILED DESCRIPTION

The preset disclosure will be described in further detail hereinafter with reference to accompanying drawings and examples to make the technical solution and merits therein clearer.

For simplicity and illustrative purposes, the present disclosure is described by referring to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

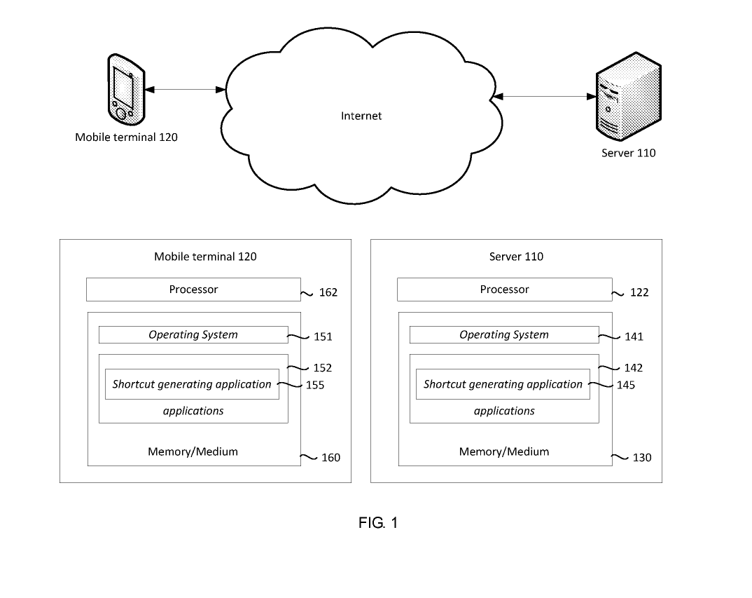

FIG. 1 is a schematic diagram illustrating a computer system according to an example of the present disclosure. As shown in FIG. 1, the computer system includes a server 110 and a mobile terminal 120.

The server 110 may vary in terms of capabilities or features. Claimed subject matter is intended to cover a wide range of potential variations. For example, the server 110 may include may execute a variety of operating systems 141 and a variety of possible applications 142, such as a desktop shortcut generating application 145.

Further, the server 110 may include one or more non-transitory processor-readable storage media 130 and one or more processors 122 in communication with the non-transitory processor-readable storage media 130.

The mobile terminal 120 may, for example, be a device such as a smart phone, Personal Digital Assistant (PDA), etc. The mobile terminal 120 may include a variety of operating systems 151 such as Android, Palm OS, Symbian, Windows mobile, Linux, iPhone OS, Black Berry OS 6.0, Windows Phone, etc.

The mobile terminal 120 may execute a variety of possible applications 152, such as a desktop shortcut generating application 155.

The mobile terminal 120 may include one or more non-transitory processor-readable storage media 160 and one or more processors 162 in communication with the non-transitory processor-readable storage media 160.

In examples of the present disclosure, the non-transitory processor-readable storage media 130 and 160 may be a RAM memory, flash memory, ROM memory, EPROM memory, EEPROM memory, registers, hard disk, a removable disk, a CD-ROM, or any other form of non-transitory storage medium known in the art. The one or more non-transitory processor-readable storage media 130 and 160 may store sets of instructions, or units and/or modules that include the sets of instructions, for conducting operations described in the present disclosure. The one or more processors may be configured to execute the sets of instructions and perform the operations in examples of the present disclosure.

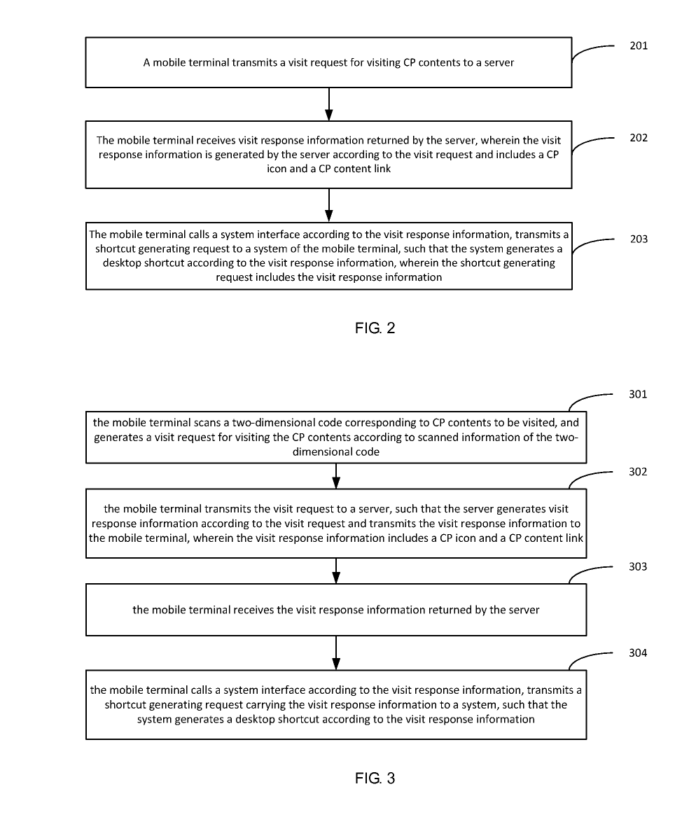

FIG. 2 is a flowchart illustrating a method for generating a desktop shortcut according to an example of the present disclosed desktop shortcut application 155. FIG. 2 is a simplified diagram according to one embodiment of the present invention. This diagram is merely an example, which should not unduly limit the scope of the claims. One of ordinary skill in the art would recognize many variations, alternatives, and modifications.

As shown in FIG. 2, the method includes at least the following processes.

At block 201, a mobile terminal transmits an visit request for visiting CP contents to a server, such that the server generates visit response information according to the visit request, wherein the visit response information includes a CP icon and a CP content link.

In this block, the mobile terminal may transmit the visit request to the server through calling a system communication interface of the mobile terminal by a first application installed in the mobile terminal.

After receiving the visit request, the server generates the visit response information according to the visit request and transmits the visit response information to the mobile terminal. The visit response information includes a CP icon and a CP content link.

At block 202, the mobile terminal receives the visit response information returned by the server.

At block 203, the mobile terminal calls a system interface of the mobile terminal according to the visit response information, transmits a shortcut generating request carrying the visit response information to a system of the mobile terminal, such that the system generates a desktop shortcut for the CP contents according to the visit response information.

In this example, the first application of the mobile terminal transmits the visit request for visiting CP contents to the server through calling the system communication interface. After receiving the visit request, the server returns visit response information including the CP icon and the CP content link to the mobile terminal. The mobile terminal transmits the shortcut generating request according to the visit response information to the system of the mobile terminal. The system generates the desktop shortcut according to the visit response information. Thus, a user of the mobile terminal is capable of browsing CP contents via the desktop shortcut on the mobile terminal, which is convenient for the user.

The CP contents are digital CP contents fit to be displayed on the mobile terminal. The CP contents may be encapsulated by other devices and directly obtained by the server. Or, the server may encapsulate the CP contents by the server itself. Various encapsulation methods may be adopted to digitalize the CP contents.

The user of the mobile terminal may know the CP contents through an address of the CP contents or other methods (e.g., through searching, or linked from other contents). The first application of the mobile terminal calls the system communication interface and transmits a visit request to the server.

After receiving the visit request transmitted by the mobile terminal, the server generates the visit response information according to the visit request and transmits the visit response information to the mobile terminal. The visit response information includes the CP icon and the CP content link. The CP icon may be a picture representing the CP contents. The CP content link may be a link of the CP contents in the server.

After receiving the visit response information, the mobile terminal calls the system interface according to the visit response information, transmits the shortcut generating request carrying the visit response information to the system. The system generates the desktop shortcut for the CP contents according to the visit response information. In one example, the mobile terminal may transmit broadcast information to the system, wherein the broadcast information includes the CP icon and the CP content link. After receiving the broadcast information, the system generates the desktop shortcut automatically.

After the desktop shortcut is generated on the mobile terminal, the mobile terminal may further transmit prompt information to the server indicating that a desktop shortcut has been generated for the CP contents.

In this example, the mobile terminal directly calls the system interface after receiving the visit response information and transmits a shortcut generating request to the system. This implementation manner is applicable for most mobile terminals. However, this implementation manner may be inapplicable for some mobile terminals. For these mobile terminals, the shortcut has to be generated by calling the system interface using a browser or an application.

In particular, for these mobile terminals, after the mobile terminal receives the visit response information, a second application (such as a browser or another application) of the mobile terminal calls the system interface and transmits the shortcut generating request to the system. In other words, the above process of calling the system interface according to the visit response information and transmitting the shortcut generating request to the system includes:

the first application transmits the visit response information to the second application; and

the second application calls the system interface according to the visit response information and transmits the shortcut generating request to the system.

FIG. 3 is a flowchart illustrating a method for generating a desktop shortcut according to another example of the present disclosure. FIG. 3 is a simplified diagram according to one embodiment of the present invention. This diagram is merely an example, which should not unduly limit the scope of the claims. One of ordinary skill in the art would recognize many variations, alternatives, and modifications.

In this example, the mobile terminal transmits a visit request through scanning a two-dimensional code corresponding to the CP contents.

As shown in FIG. 3, the method includes the following processes.

At block 301, the mobile terminal scans a two-dimensional code corresponding to CP contents to be visited, and generates a visit request for visiting the CP contents according to scanned information of the two-dimensional code.

At block 302, the mobile terminal transmits the visit request to a server, such that the server generates visit response information according to the visit request and transmits the visit response information to the mobile terminal, wherein the visit response information includes a CP icon and a CP content link.

At block 303, the mobile terminal receives the visit response information returned by the server.

At block 304, the mobile terminal calls a system interface according to the visit response information, transmits a shortcut generating request carrying the visit response information to the system, such that the system generates a desktop shortcut for the CP contents according to the visit response information.

In this example, the user is not required to know the address of the CP contents. Through scanning the two-dimensional code, the mobile terminal is capable of transmitting the visit request to the server, which is convenient for the user.

In this example, the two-dimensional code is corresponding to the CP contents to be visited. It may be exhibited on magazines, advertisements, or other media. The two-dimensional code may be generated via various kinds of methods, which is not restricted in the present disclosure. After the two-dimensional code corresponding to the CP contents is distributed, the user of the mobile terminal is able to visit the CP contents through scanning the two-dimensional code.

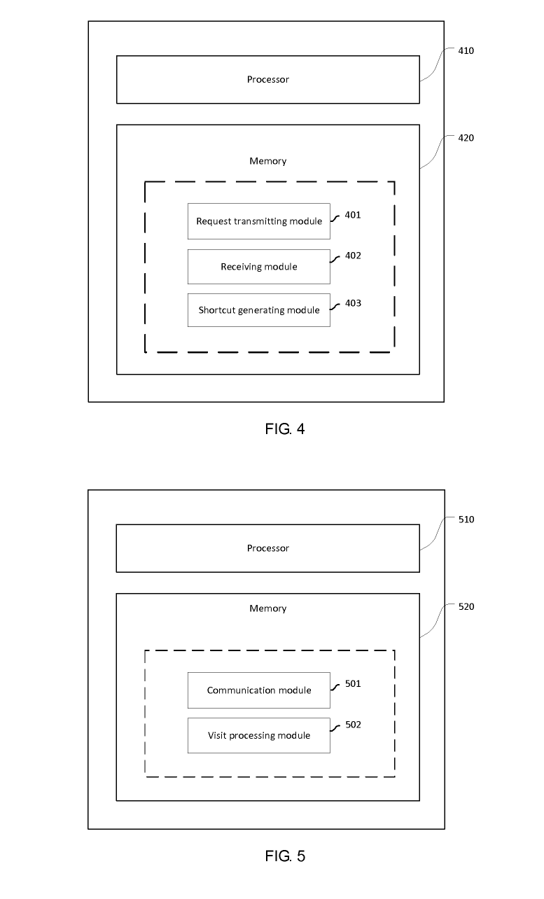

In accordance with the above methods, an example of the present disclosure provides a mobile terminal. FIG. 4 is a schematic diagram illustrating a mobile terminal according to an example of the present disclosure. FIG. 4 is a simplified diagram according to one embodiment of the present invention. This diagram is merely an example, which should not unduly limit the scope of the claims. One of ordinary skill in the art would recognize many variations, alternatives, and modifications.

As shown in FIG. 4, the mobile terminal includes:

one or more processors 410;

a memory 420; and

one or more program modules stored in the memory 420 and to be executed by the one or more processors 410, the one or more program modules include:

a request transmitting module 401, adapted to transmit a visit request for visiting CP contents to a server;

a receiving module 402, adapted to receive visit response information from the server, wherein the visit response information is generated by the server and includes a CP icon and a CP content link; and

a shortcut generating module 403, adapted to call a system interface according to the visit response information, transmit a shortcut generating request including the visit response information to a system of the mobile terminal, such that the system generates a desktop shortcut for the CP contents according to the visit response information.

In this example, the request transmitting module 401 may transmit the visit request to the server through calling a system communication interface of the mobile terminal.

The user of the mobile terminal may know the CP contents through an address of the CP contents or other methods (e.g., through searching, or linked from other contents). The request transmitting module 401 of the mobile terminal calls the system communication interface and transmits a visit request to the server.

The mobile terminal may also generate the visit request through scanning a two-dimensional code corresponding to the CP contents. Thus, the user is not required to know the address of the CP contents. Through scanning the two-dimensional code, the request transmitting module 401 of the mobile terminal is capable of transmitting the visit request to the server, which is convenient for the user.

In this example, the mobile terminal directly calls the system interface after receiving the visit response information and transmits a shortcut generating request to the system. This implementation manner is applicable for most mobile terminals. However, this implementation manner may be inapplicable for some mobile terminals. For these mobile terminals, the shortcut has to be generated calling the system interface using a browser or an application.

In particular, for these mobile terminals, after the mobile terminal receives the visit response information, a second application (such as a browser or another application) of the mobile terminal calls the system interface and transmits the shortcut generating request. In other words, the shortcut generating module 403 transmits the visit response information to the second application; and the second application calls the system interface according to the visit response information and transmits the shortcut generating request to the system.

In this example, the processor 410 may execute the program modules in the memory 420 to further execute all or some of the processes described in the above method examples, which is not repeated herein.

FIG. 5 is a schematic diagram illustrating a server according to an example of the present disclosure. As shown in FIG. 5, the server includes:

one or more processors 510;

a memory 520; and

one or more program modules stored in the memory 520 and to be executed by the one or more processors 510, the one or more program modules include:

a communication module 501, adapted to receive a visit request transmitted by a mobile terminal for visiting CP contents, and transmit visit response information generated by a visit processing module 502 to the mobile terminal, such that the mobile terminal generates a desktop shortcut according to the visit response information; and

the visit processing module 502, adapted to generate the visit response information according to the visit request, wherein the visit response information includes a CP icon and a CP content link.

In this example, the processor 510 may execute the program modules in the memory 520 to further execute all or some of the processes described in the above method examples, which is not repeated herein.

What has been described and illustrated herein is a preferred example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

1. A method for generating a desktop shortcut, comprising:
transmitting, by a mobile terminal, a visit request for visiting Content Provider (CP) contents to a server;
receiving, by the mobile terminal, visit response information returned by the server, wherein the visit response information is generated by the server according to the visit request and comprises a CP icon and a CP content link; and
transmitting, by the mobile terminal, a shortcut generating request containing the visit response information to a system of the mobile terminal through calling a system interface, such that the system of the mobile terminal generates a desktop shortcut for the CP contents according to the visit response information.

2. The method of claim 1, further comprising:
before transmitting the visit request to the server,
scanning, by the mobile terminal, a two dimensional code corresponding to the CP contents; and
generating, by the mobile terminal, the visit request according to scanned information of the two-dimensional code.

3. The method of claim 1, wherein the transmitting the shortcut generating request to the system of the mobile terminal through calling the system interface comprises:
transmitting, by a first application of the mobile terminal which receives the visit response information returned by the server, the visit response information to a second application of the mobile terminal; and
transmitting, by the second application, the shortcut generating request to the system through calling the system interface.

4. A method for generating a desktop shortcut, comprising:
receiving, by a server, a visit request transmitted by a mobile terminal for visiting Content Provider (CP) contents;
generating, by the server, visit response information according to the visit request, wherein the visit response information comprises a CP icon and a CP content link; and
transmitting, by the server, the visit response information to the mobile terminal, such that the mobile terminal generates a desktop shortcut for the CP contents according to the visit response information.

5. The method of claim 4, wherein the visit request is generated by the mobile terminal through scanning a two-dimensional code corresponding to the CP contents.

6. A mobile terminal for generating a desktop shortcut, comprising:
one or more processors;
a memory; and
one or more program modules stored in the memory and to be executed by the one or more processors, the one or more program modules comprise:
a request transmitting module, adapted to transmit a visit request for visiting CP contents to a server;
a receiving module, adapted to receive visit response information from the server, wherein the visit response information is generated by the server and comprises a CP icon and a CP content link; and
a shortcut generating module, adapted to call a system interface according to the visit response information, transmit a shortcut generating request comprising the visit response information to a system of the mobile terminal, such that the system generates a desktop shortcut for the CP contents according to the visit response information.

7. The mobile terminal of claim 6, wherein the request transmitting module is further adapted to generate the visit request through scanning a two-dimensional code corresponding to the CP contents.

8. The mobile terminal of claim 6, wherein the receiving module receives the visit response returned by the server via a first application; the shortcut generating module is further adapted to transmit the visit response information to a second application which transmits the shortcut generating request to the system through calling the system interface.
